(19) United States
(12) Patent Application Publication
(10) Pub. No.: US 2002/0037192 A1
(43) Pub. Date: Mar. 28, 2002

(54) Method and arrangement at a flagpole

(76) Inventor: Bernt Eriksson, Tidaholm (SE)

Correspondence Address: MERCHANT & GOULD P.C., P.O. Box 2903, Minneapolis, MN, 55402-0903, US

(21) Appl. No.: 09/918,859

(22) Filed: Jul. 31, 2001

Related U.S. Application Data
(63) Continuation-in-part of application No. 09/284,827, filed on Apr. 21, 1999, now Pat. No. 6,287,042.

(30) Foreign Application Priority Data
Oct. 31, 1996 (SE) 9603994-6

(51) Int. Cl. B25G 3/34; F16B 11/00; F16B 12/04; F16L 13/00

(52) U.S. Cl. 403/267

(57) ABSTRACT

The invention relates to a process and a device for dividing a tubular flagpole. This is achieved by introducing into the flagpole an elongated body, which over at least part of its length has a geometric shape, which in concert with a complementary geometric shape inside the flagpole ensures that the flagpole can be cut and assembled in a way that guarantees the rectilinear continuity of the flagpole. The complementary geometric shape is formed in that, after the body is introduced into the flagpole, a filling material is injected so that the space between the flagpole and the elongated body is filled. The flagpole is then cut around the elongated body down to the outer surface of the body so that the said geometric shape allows the flagpole to be divided into two sections at the cutting side, the body remaining fixed to one of the sections.

This application is a Continuation-in-Part of U.S. patent application Ser. No. 09/284,827, filed Apr. 21, 1999, which application(s) are incorporated herein by reference.

### FIELD OF THE INVENTION

The present invention relates to a process for dividing a tubular flagpole.

The invention also relates to a device in a tubular flagpole, allowing the flagpole to be divisible into first and second flagpole sections.

### BACKGROUND OF THE INVENTION

Flagpoles are often very long. This may cause difficulties, for example, when transporting them, partly for reasons of space and partly because they are awkward to handle. It is therefore desirable that the flagpoles be divisible into two or more parts.

A device for achieving a rigid and rattle-free connection of two flagpole sections is already known from SE 464 037. The device is used to connect two tubes of different diameter, where the outside diameter of the first tube is smaller than the inside diameter of the second tube. The first tube has two sleeves with a plurality of peripheral slots, designed to receive O-rings. The first sleeve is arranged at a free end of the first tube and the second sleeve is arranged further in on the tube. The second sleeve, at the end furthest away from the first sleeve, is equipped with a flange, the diameter of which is greater than the inside diameter of the second tube. When connecting the sections of the flagpole, the first tube provided with sleeves is inserted into the second tube so that the first sleeve is situated entirely inside this tube and the second sleeve is situated partially inside the tube, with its flange resting against the end of the second tube. The O-rings on the sleeves are designed so that they come into contact with the inside of the second tube, thereby achieving a rattle-free connection.

A disadvantage with this device is that it requires flagpole sections of different diameters. This means that these flagpoles differ significantly in appearance from conventional, non-divisible flagpoles.

A flagpole of tubular metal sections with successively diminishing diameters, which are connected by pipe studs inserted into the ends of the tubular sections, which connect the tubular sections to one another, is also known from U.S. Pat. No. 1,102,413. The tubular sections have been shrunk fast in the pipe stubs and their projecting parts are provided with external threads corresponding with internal threads on a coupling piece, which connects the tubular sections in that their respective threaded pipe studs are firmly screwed into this coupling piece.

A disadvantage with this flagpole is that the joints are made up of a plurality of components which require accurate assembly and adjustment in order to achieve a satisfactory joint. The coupling piece in this device is clearly visible on the outside of the flagpole when the two flagpole sections are assembled. Furthermore this device also involves coupling together flagpole sections of different diameter, which means that the flagpole differs significantly in appearance from conventional, non-divisible flagpoles.

### SUMMARY OF THE INVENTION

The invention provides a method which overcomes the disadvantages associated with previously known solutions, in which method

an elongated body is chosen, which over at least one part of its length has a geometric shape, which in its interaction with a complementary geometric shape inside the flagpole ensures that the flagpole can be cut and assembled in a away that guarantees that the flagpole remains straight when assembled, and over its entire length has an outside dimension less than the inside diameter of the flagpole,

non-stick agent is applied to the outer surface of the elongated body on a part of its length, including one end of the body and at least one part of the said geometric shape,

the elongated body is inserted into the flagpole and placed with its centre essentially where division is required,

a seal is produced between the flagpole and the elongated body at both ends of the body, thereby forming an enclosed space,

at least one hole is made though the wall of the flagpole so that the hole(s) communicate(s) with the enclosed space,

a filling material, preferably thermosetting plastic, is injected through the hole(s) (6a, 6b) so that the space between the flagpole and the elongated body is filled, thereby forming the said complementary geometric shape,

the filling material is allowed to set, so that the elongated body is thereby fixed to the flagpole by that part of its outer surface to which non-stick agent has not been applied,

the flagpole is cut away around the elongated body, at an area on this to which non-stick agent has been applied, down to the outer surface of the body, so that a certain length of the body remains on both sides around the cutting site, and so that it is possible to divide the flagpole into two parts at the cutting site, the body remaining fixed to one of the parts.

According to another embodiment of the invention the elongated body is a tube, in which case it is possible to form the enclosed space by introducing an expandable agent, in one simple, advantageous embodiment a rubber bladder, into the tube and causing this to expand so that it protrudes from the tube at both ends thereof and in such a way as to form a seal between the tube and the flagpole, as a result of which the tube is also centered in the flagpole.

According to another characteristic of the invention a plurality of elongated bodies are arranged in the flagpole in order to permit dividing at a plurality of points.

Another object of the invention is to produce a device by means of which the above-mentioned disadvantages are overcome. This is achieved by the invention in that a tube is introduced and fixed in the first flagpole section at its end corresponding to the second flagpole section, so that one part of the tube protrudes from the first flagpole section, the protruding part of the tube having a geometric shape corresponding to a complementary geometric shape inside the second flagpole section at its end corresponding to the first flagpole section, in which the said fixing and said complementary geometric form are respectively produced by the injection of a filling material, preferably thermosetting plastic, between the tube and the flagpole so that, after setting, this filling material together with the tube with the said geometric shape mean that the flag pole, after dividing around the tube down to this can only be assembled in a way that guarantees that the flagpole remains straight.

In order to obtain an uncomplicated design, the said geometric shape, according to a further characteristic of the invention, comprises at least one guide extending along the said tube which in one simple embodiment is an axially aligned key.

According to yet another characteristic of the invention at least one part of the outer surface of that part of the tube fixed in the first flagpole section to ensure its fixing is provided with a friction-enhancing external texture, consisting in one embodiment of grooves.

In a further embodiment of the invention the flagpole sections may be attached by a flagpole tube wherein various slits and holes are aligned and fastened with the appropriate screws, bolts, or pins.

A further advantage of the invention is to make it easier to transport flagpoles. Because of the length of flagpoles these must be transported long vehicles and actions must be taken to make it possible for the vehicle, in spite of the length of the flagpoles, to follow the curves of the road.

### BRIEF DESCRIPTION OF THE FIGURES

The invention will be explained in more detail below with the aid of examples and with reference to the drawings attached in which:

FIG. 1 shows a perspective view of an elongated body for use in an embodiment of the invention,

FIG. 2 shows a section through the body and the flagpole at one phase in a process according to the invention,

FIG. 3 shows a section through the body and the flagpole at another phase in a process according to the invention;

FIG. 4 shows a perspective view of an embodiment of the device according to the invention.

FIG. 5 through 7 depict perspective views of further alternative embodiments of flagpole assemblies in accordance with the invention.

### DETAILED DESCRIPTION OF THE PREFERRED EMBODIMENTS

The invention is a flagpole assembly illustrated through various embodiments depicted in FIGS. 1 through 8.

FIG. 1 shows an example in which approximately half the elongated body, of tube 2, has a grooved outer surface 2b and approximately half has an outer surface 2a to which a non-stick agent is applied. In addition a longitudinal key 3 is arranged approximately in the centre of the tube 2, to one part of which, corresponding to the outer non-stick coated surface 2a, non-stick agent is applied.

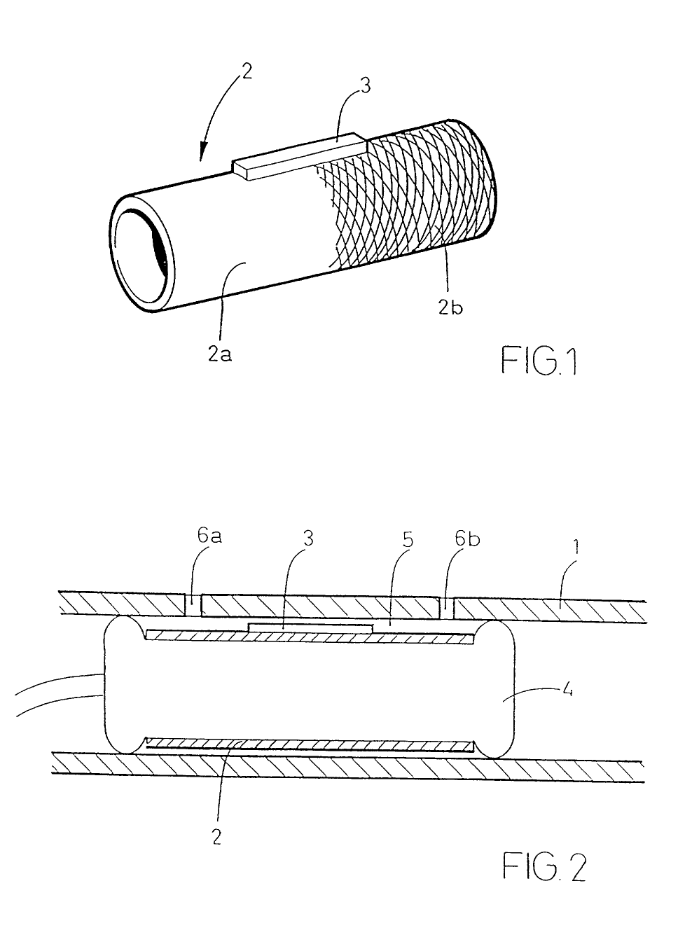

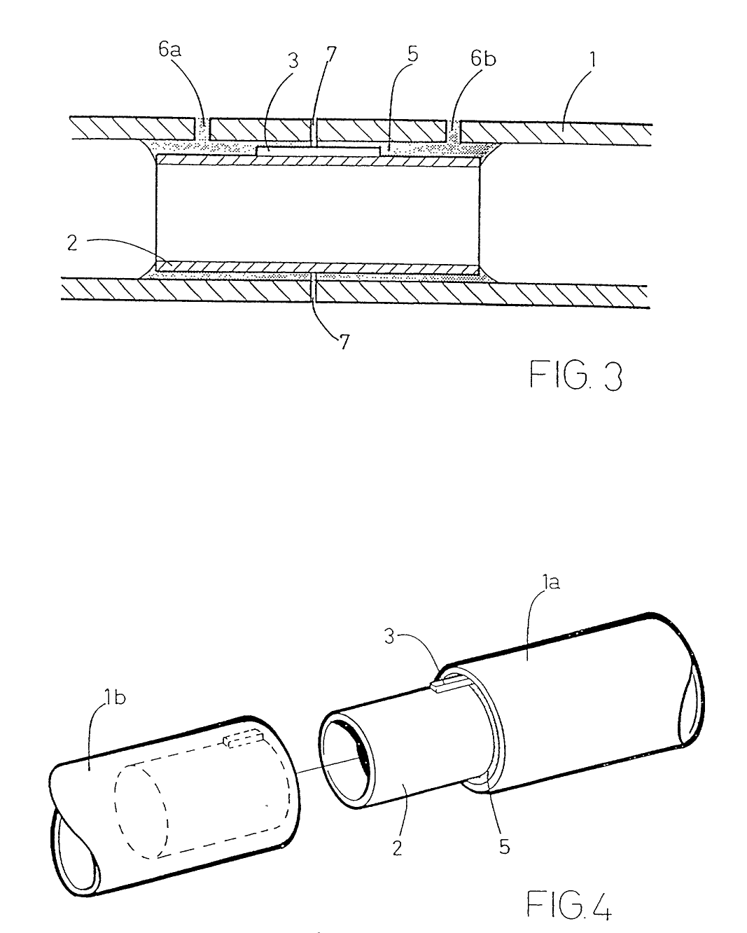

In the example in FIG. 2 the tube 2 has been placed in an axial direction in a tubular flagpole 1 with its centre approximately where the division is required. The flagpole 1 may be of a prefabricated type and manufactured from glass fibre-reinforced thermosetting plastic. A rubber bladder 4 may be placed inside the tube 2. The bladder 4 expanded by filling it with air. The space between the flagpole and the tube is sealed at both ends of the tube, so that an enclosed space 5 has been formed. Furthermore, the expansion also results in centering the tube 2 in the flagpole 1. The rubber bladder 4 may have been placed in the tube 2 either before this was inserted into the flagpole or afterwards. Sealing may naturally be performed in a number of other ways well-known to the person skilled in the art. Two holes 6a, 6b may also be formed in flagpole 1 so that the holes communicate with the enclosed space. In the example in FIG. 3 a thermosetting plastic, for example a two-component thermosetting plastic, has been injected through the holes 6a, 6b so that the enclosed space 5 between the flagpole 1 and the tube 2 is filled. In one embodiment the tube 2 and the thermosetting plastic have approximately the same coefficient of thermal expansion. In this example the rubber bladder 4 has been removed after the thermosetting plastic was injected, which is naturally not necessary. The thermosetting plastic is fixed at the flagpole 1 and the tube 2, at that part of its outer surface to which non-stick agent is not applied, by allowing it to harden. The grooves 2b on the outer surface of the tube 2 immersed in the thermosetting plastic make the fixing stronger.

After the thermosetting plastic has been allowed to set, the flagpole 1 is cut into two sections at a cutting site 7. The cutting is performed around the tube 2 so that the wall of the flagpole 1 and the thermosetting plastic are cut through whilst the tube 2 remains intact. In one example the key 3 is at least partially severed. In this example the cutting is performed approximately in the middle of the longitudinal key 3 and where the non-stick agent is applied to this. After cutting, a length of the tube 2 remains on both sides of the cutting site. It is now possible to divide the flagpole into two sections 1a, 1b at the cutting site, as shown in FIG. 4, in which the tube remains fixed to the one section 1a. It is advantageous to perform the cutting in such a way that as small an area as possible has non-stick agent on the length to which non-stick agent is not applied to the entire outer surface.

As shown in the example in FIG. 4, the key 3 and the thermosetting plastic now ensure that assembly can only be undertaken in such a way that the flagpole regains its original alignment, that is to say just as the flagpole was aligned before it was cut off, that the assembled sections 1a, 1b cannot be twisted in relation to one another and that the rectilinear continuity of the flagpole is regained when the flagpole sections 1a and 1b are assembled.

In another example (not shown) either non-stick agent is applied to more than half of the tube 2 and less than half of the tube is grooved, or non-stick agent is applied to less than half of the tube 2 and more than half of the tube is grooved. Non-stick agent is applied to at least part of the key 3 and the cutting should be performed so that at least one part of the key 3 does not remain fixed inside the flagpole section 1a.

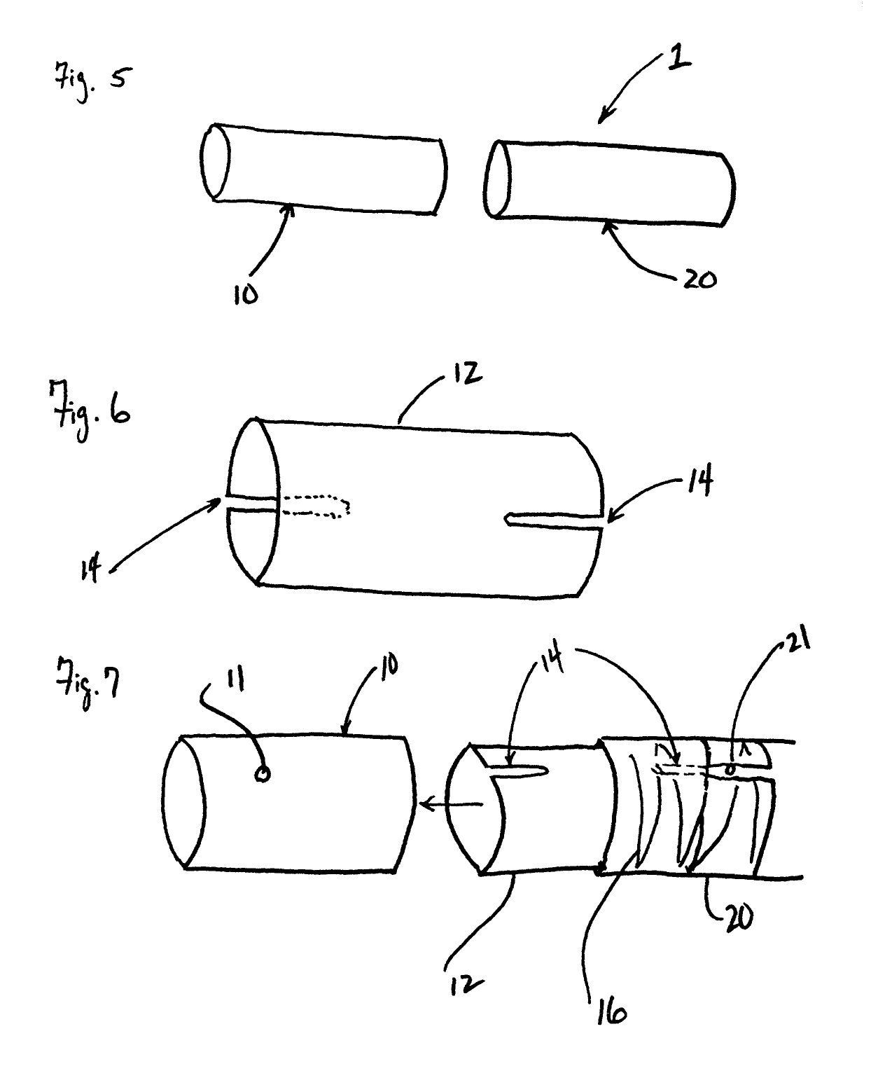

According to an alternative embodiment the invention the flagpole 1 is divided in two or more parts 10 and 20 each having a length of about 4 meters (see FIG. 5). An elongated body A is provided (FIG. 6) having an outer diameter slightly less than the inner diameter of the flagpole parts 10 and 20. The body may be a tube of glass fibre reinforced polyester or of aluminium. One or more slits 14 (FIG. 6) may be made from one or both of the ends of the elongated body 12 and holes 11 and 21 are drilled in the flagpole parts in such a way that they coincide with slits 14.

Before the flagpole is to be erected the parts 10 and 20 are joined together by using the elongated body 12 which is inserted into the ends of the flagpole parts 10 and 20. Screws may then be inserted into the holes 11 and 21 and screwed into the slits 14. The end diameter of the elongated body 12 is widened to anchor the elongated body 12 in the flagpole parts 10 and 20 which thus are locked together.

The joint between the flagpole parts 10 and 20 may be improved by applying a two-component adhesive 16 on the body before inserting it into the respective ends of the flagpole parts 10 and 20.

In the second embodiment the anchoring between the elongated body 12 and the parts 10 and 20 may be achieved by only two-component adhesive 16, e.g. without slits and screws.

It will be obvious to the person skilled in the art that the invention is not confined to the examples described above but can lend itself to modifications within the framework of the idea of the invention defined n the claims below.

The claimed invention is:

1. A flag pole assembly comprising:
a.) a first piece;
b.) a second piece;
c.) an elongate body having first and second ends, wherein said elongate body fits within said first piece and said second piece interconnecting said first and second pieces, and wherein said elongate body first and second ends are expandable to lock said first and second pieces together.

2. The assembly of claim 1, wherein said elongate body has a first end and a second end, said body first end having a first slit and said body second end having a second slit.

3. The assembly of claim 2, wherein said first piece has a first hole and said second piece has a second hole and when assembled, said first piece first hole is aligned with said body first slit and said second piece second hole is aligned with said body second slit.

4. The assembly of claim 3, additionally, comprising first and second pin means, wherein said first pin means is inserted into said first hole and first slit, and said second pin means is inserted into said second hole and second slit.

5. The assembly of claim 4, wherein said first and second pin means are individually selected from the group of a screw, a bolt, and a pin.

6. The assembly of claim 4, additionally comprising adhesive, wherein said thermosetting adhesive is applied to said elongate body.
